(19) United States
(12) Patent Application Publication
(10) Pub. No.: US 2012/0288045 A1
(43) Pub. Date: Nov. 15, 2012

(54) SIGNAL RECEIVING APPARATUS AND METHOD OF CONTROLLING FILTERS IN SIGNAL RECEIVING APPARATUS

(75) Inventor: Seiji NAKANISHI, Tokyo (JP)

(73) Assignee: LAPIS SEMICONDUCTOR CO., LTD., Tokyo (JP)

(21) Appl. No.: 13/468,480

(22) Filed: May 10, 2012

(30) Foreign Application Priority Data
May 11, 2011 (JP) 2011-106373

(51) Int. Cl. H04B 1/10

(52) U.S. Cl. 375/350

(57) ABSTRACT

A signal receiving device receives an incoming signal to obtain a frequency signal. The signal receiving device has a multi-filter device. The frequency signal is subjected to frequency selection processing by using the multi-filter device. The multi-filter device has a plurality of filters whose frequency characteristics are different from each other. The filters are connected in series. If the received signal intensity is higher than prescribed threshold intensity, the center frequency of at least one of the filters in the multi-filter device is biased.

### FIELD OF THE INVENTION

The present invention generally relates to a signal receiving apparatus and in particular it relates to an apparatus that receives and demodulates a signal wirelessly transmitted and also relates to a control method for multiple filters installed in such apparatus.

### DESCRIPTION OF THE RELATED ART

One of known signal receiving apparatuses operates in the following manner. An IF (intermediate frequency) signal is obtained by converting a received RF (radio frequency) signal into an intermediate frequency band, and this IF signal is subjected to frequency selection processing using an analog band pass filter (hereafter referred to as an analog BPF). Then, the signal after the processing is demodulated so as to restore information and/or data carried on the received RF signal.

The above-mentioned analog BPF is required to have a high Q value in order to increase the interference resistance at the time of signal reception. A filter device for realizing a desired attenuation characteristic and passband is also known. In this filter device, a plurality of filters having different frequency characteristics are connected in series (hereafter referred to as a multi-filter device). Such filter device is, for example, disclosed in FIG. 1 or 3 of Japanese Patent Application Publication (Kokai) No. 8-172338.

In the filter having the above-described constitution, however, a demodulation error may increase due to a group delay of the filter as shown in FIG. 1 of the accompanying drawings. Specifically, the center part of the frequency band curve, indicated by the solid line in FIG. 1, becomes concaved while the both sides thereof are convexed (i.e., the group delay has two peaks in the middle).

In order to eliminate or reduce the demodulation error, a particular digital filter may be provided immediately after the analog BPF, as disclosed in FIG. 1 of Japanese Patent Application Publication No. 2002-141821. Specifically, the group delay characteristic may be offset by the digital filter having an inverse characteristic of group delay characteristic of the analog BPF.

In recent years, an active type filter having an amplifier thereon is used as the analog BPF so as to realize both size reduction and good filter characteristics. In a signal receiving apparatus equipped with the active type filter, drive current of the amplifier of the analog BPF is suppressed such that the apparatus consumes less power and the saturation amplified voltage output is set to a low value (for example, 1.5 V). When the saturation amplified voltage output of the amplifier is reduced, the amplifier operates close to a saturation zone when the level of an RF signal becomes relatively large (e.g., 1.2 V). For example, if a signal receiving apparatus is placed near a signal transmitting apparatus, that is to say, when so-called short-range communications are executed, the level of the RF signal becomes large. As described above, when the amplifier operates close to the saturation zone, the group delay characteristic of the analog BPF changes from the state indicated by the solid line in FIG. 1 to the state indicated by the broken line in FIG. 1. If the received signal strength is high, a changing amount of the group delay at each frequency is larger than when the received signal strength is low.

When a short-range (or short distance) communication is carried out and the center frequency of a received signal is deviated from a desired center frequency due to a frequency deviation of a signal transmitting apparatus or an initial deviation of a center frequency of a local oscillator on the signal receiving apparatus side, then a signal having a frequency band desired by the BPF cannot be passed and hence accurate data demodulation becomes difficult.

### SUMMARY OF THE INVENTION

One purpose of the present invention is to provide a signal receiving apparatus that is capable of performing highly accurate demodulation regardless of received signal strength.

Another purpose of the present invention is to provide a control method for multiple filters used in the signal receiving apparatus to attain highly accurate demodulation regardless of received signal strength.

According to a first aspect of the present invention, there is provided a signal receiving apparatus that includes a multi-filter device. The multi-filter device includes a plurality of filters. These filters have different frequency characteristics from each other, and are connected to each other in series. The signal receiving apparatus includes a unit for obtaining a frequency signal from an incoming signal (i.e., received signal). The frequency signal is then subjected to frequency selection processing. The frequency selection processing is carried out by the multi-filter device. The signal receiving apparatus also includes a demodulation part to demodulate a processed signal that has been subjected to the frequency selection processing so as to obtain information and/or data. The information and data may be an output from the signal receiving apparatus. The signal receiving apparatus also includes a received signal intensity determination part to determine whether the received signal intensity is greater than threshold intensity. The signal receiving apparatus also includes a controlling part to bias (or shift) the center frequency of at least one filter of the multi-filter device when the received signal intensity determination part determines that the received signal intensity is greater than the threshold intensity.

According to another aspect of the present invention, there is provided a control method for a multi-filter device included in a signal receiving apparatus. The multi-filter device includes a plurality of filters having different frequency characteristics. These filters are connected to each other in series. A frequency signal is prepared in the signal receiving apparatus upon receiving a transmitted signal. The frequency signal is subjected to frequency selection processing by the multi-filter device. The center frequency of at least one filter of the multi-filter device is biased when the received signal intensity is higher than the threshold intensity.

When a frequency signal derived from the received signal is subjected to the frequency selection processing by the multi-filter device and the received signal intensity is high enough to reach (or almost reach) a saturation zone of an amplifier installed in the multi-filter device, then the center frequency of at least one filter in the multi-filter device is biased. By biasing the filter center frequency toward a direction away from the center frequency of the multi-filter device, the pass band width of the multi-filter device becomes wider, while a changing amount of the group delay is reduced. Therefore, when the changing amount of the group delay of the multi-filter device is large due to high received signal intensity, it is still possible to extract a signal having a desired band to be demodulated, even if the center frequency of the received signal is deviated from a prescribed center frequency. Thus, it is possible perform highly accurate demodulation.

These and other objects, aspects and advantages of the present invention will become apparent to those skilled in the art from the following detailed description when read and understood in conjunction with the appended claims and drawings.

### BRIEF DESCRIPTION OF THE DRAWINGS

FIG. 1 illustrates an example of a group delay characteristic of an analog band pass filter at a time of long-range wireless communication and short-range wireless communication respectively.

FIG. 2 is a block diagram of a signal receiving apparatus according to one embodiment of the present invention.

FIG. 3 is a block diagram illustrating an example of an internal constitution of a BPF provided in the signal receiving apparatus shown in FIG. 2.

FIG. 4 is a circuit diagram illustrating an exemplary one of filters provided in the BPF shown in FIG. 3.

FIG. 5A illustrates an example of a frequency characteristic of the BPF in a low received signal intensity mode.

FIG. 5B illustrates an example of a frequency characteristic of the same BPF in a high received signal intensity mode.

FIG. 6A illustrates an example of a group delay characteristic of the BPF in the low received signal intensity mode.

FIG. 6B illustrates an example of a group delay characteristic of the same BPF in the high received signal intensity mode.

FIG. 7A is a circuit diagram illustrating a modification to variable resistances shown in FIG. 4.

FIG. 7B is another circuit diagram illustrating a modification to variable capacitors shown in FIG. 4.

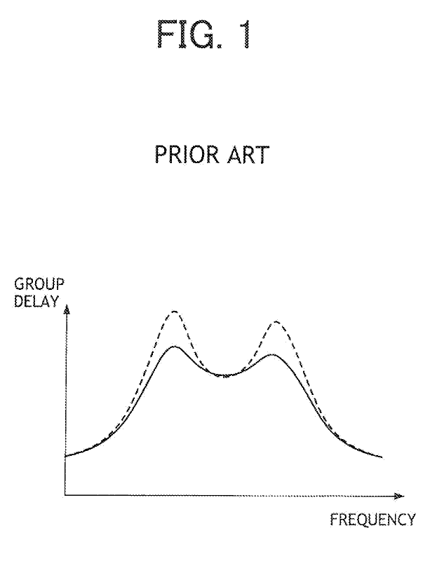

### DETAILED DESCRIPTION OF THE INVENTION

The multi-filter device of the present invention has a plurality of filters. These filters have different frequency characteristics from each other, and are connected in series. When a frequency signal derived from a received signal is subjected to frequency selection processing by the multi-filter device and received signal intensity is greater than prescribed threshold intensity, then the center frequency of at least one of the filters in the multi-filter device is biased.

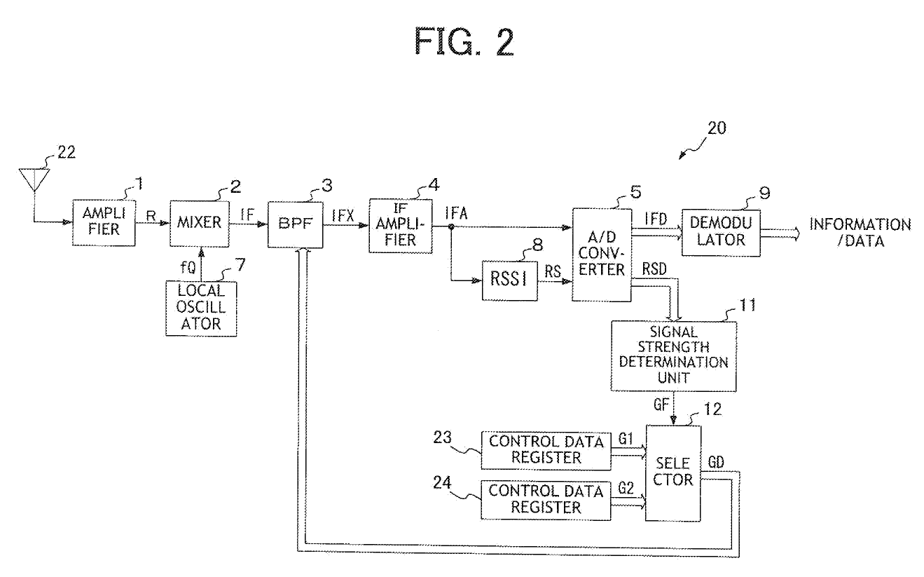

Referring to FIG. 2, an overall constitution of a signal receiving apparatus 20 according to one embodiment of the present invention will be described.

In FIG. 2, a transmitted signal wirelessly transmitted from the transmitting apparatus (not illustrated) is received by an antenna 22 of the signal receiving apparatus 20, and an RF signal received by the antenna 22 is supplied to an amplifier 1 as a received signal. The amplifier 1 amplifies the received signal and supplies an amplified signal R to a mixer 2. The mixer 2 mixes the amplified signal R with a local oscillation signal fQ supplied from a local oscillation circuit 7 so as to generate an intermediate frequency signal IF having an intermediate frequency band. The mixer 2 supplies the intermediate frequency signal IF to a band pass filter (hereafter referred to as BPF) 3.

The BPF 3 applies the frequency selection processing on the intermediate frequency signal IF to allow passage of only a component of a prescribed frequency band with a center frequency fc at the center, and extracts an intermediate frequency signal IFX from which an unnecessary band component is removed. The BPF 3 then supplies the intermediate frequency signal IFX to an intermediate frequency amplifying circuit 4. The BPF 3 is a multiple-filter device that is capable of changing the filter characteristic based on filter control data GD (will be described below).

The intermediate frequency amplifying circuit 4 amplifies the intermediate frequency signal IFX and supplies the resulting signal (i.e., amplified intermediate frequency signal) IFA to both an A/D converter 5 and an RSSI (Received Signal Strength Indicator) circuit 8. The RSSI circuit 8 serves as a received signal intensity measurement circuit. The RSSI circuit 8 rectifies the amplified intermediate frequency signal IFA to measure the intensity of the signal received at the antenna 22 and supplies a received signal intensity signal RS indicating the received signal strength to the A/D converter 5. The A/D converter 5 converts the amplified intermediate frequency signal IFA into a digital value (i.e., intermediate frequency signal IFD) and supplies the intermediate frequency signal IFD to a demodulation circuit 9. The A/D converter 5 also converts the intensity signal RS into a digital value (i.e., received signal intensity signal RSD) and supplies the received signal intensity signal RSD to a received signal level determining circuit 11. The demodulation circuit 9 applies demodulation processing on the intermediate frequency signal IFD to restore the information and/or data wirelessly transmitted to the signal receiving apparatus 20. The demodulation circuit 9 may supply the resulting information and/or data to a signal reception controlling part (not shown) or to another device (not shown).

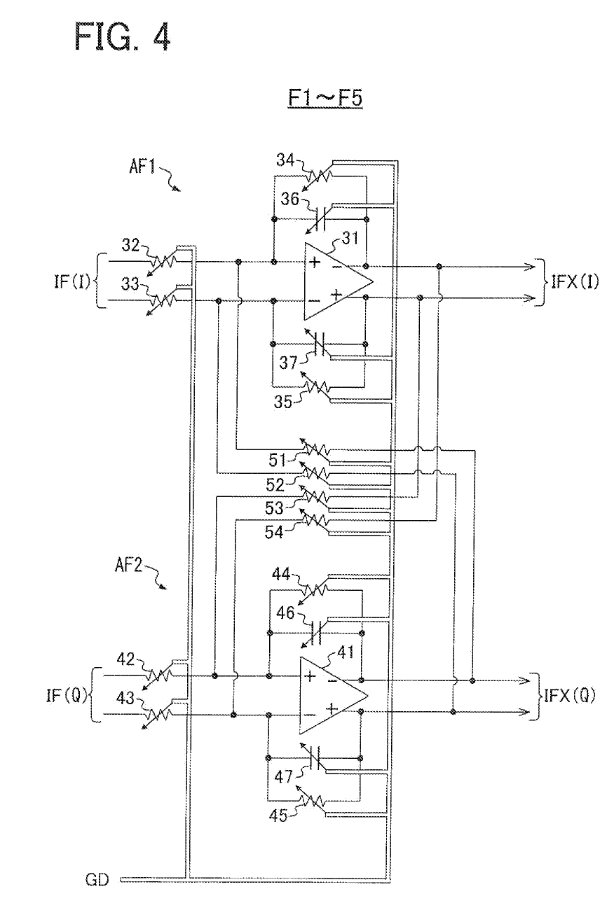

The received signal level determination circuit 11 determines whether or not the received signal strength indicated by the received signal intensity data RD is greater than threshold intensity RG. When the received signal strength is greater than the threshold value RG, then a strong signal reception detecting flag GF of logical level 1 is supplied to a selector 12. When the received signal strength is not greater than the threshold value RG, the flag GF of logical level 0 is supplied to the selector 12. Since a data error occurs when the operational amplifier (FIG. 4; to be described below) of the BPF 3 reaches saturation due to a deviation of the center frequency of the received signal, it is preferred to set the threshold intensity RG to a level lower than the level at which the operational amplifier saturates (for example, −90 dBm).

A control data register for high signal intensity 23 stores, in advance, filtering control data G1 for high received signal intensity. The control data G1 becomes optimal when the received signal intensity is higher than the threshold value RG. The filter control data is used to set (or decide) the filter characteristic of the BPF 3. The control data register for high intensity signal 23 supplies the filtering control data G1 to the selector 12.

The signal receiving apparatus 20 has another control data register 24. This register 24 is provided for low intensity signal, and stores in advance filtering control data G2 for low intensity received signal. The control data G2 becomes optimal when the received signal intensity is not greater than the threshold value RG. The second control data register 24 supplies the filtering control data G2 to the selector 12.

On the basis of the received signal strength flag GF supplied from the received signal level determination circuit 11, the selector 12 selects either the high intensity signal filtering control data G1 or low intensity signal filtering control data G2, and supplies the selected signal to the BPF 3 as the filter control data GD. Specifically, upon receiving the signal strength flag GF of logical level 1, i.e., when the received signal intensity is higher than the threshold intensity RG, then the selector 12 selects the high intensity signal filtering control data G1, and supplies it to the BPF 3 as the filter control data GD. On the other hand, when the signal strength flag GF of logical level 0 is supplied to the selector 12 from the received signal level determining circuit 11, i.e., when the received signal intensity is not higher than the threshold intensity RG, the selector 12 selects the low intensity signal filtering control data G2, and supplies it to the BPF 3 as the filter control data GD.

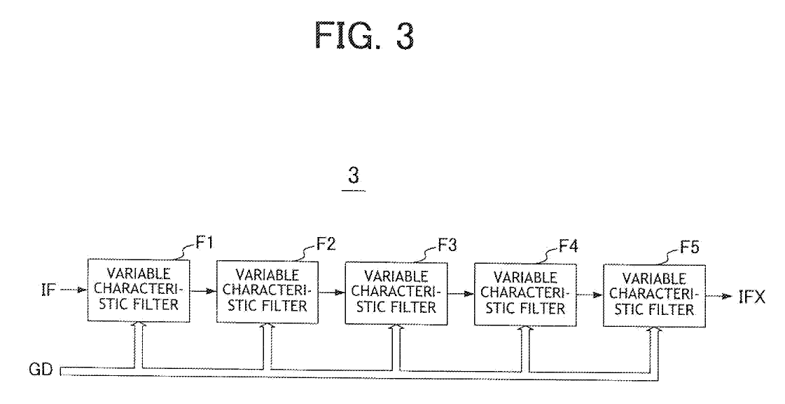

Referring now to FIG. 3, an exemplary internal constitution of the BPF 3 will be described.

As illustrated in FIG. 3, the BPF 3 is a multi-filter device having five filters F1-F5. The filters F1-F5 have different frequency characteristics and are connected in series. The filters F1-F5 are variable characteristic filters. In this embodiment, the filters F1-F5 have the same internal configuration, but can have different frequency characteristics by means of the filter control data GD supplied to the filters F1-F5, respectively (or individually).

Referring to a circuit diagram shown in FIG. 4, the internal constitution of each of the filters F1-F5 will be described. As mentioned earlier, the filters F1-F5 have the same configuration.

In FIG. 4, the filter has two active filters AF1 and AF2 and variable resistances 51-54. The first active filter AF1 includes an operational amplifier 31, variable resistances 32-35, and variable capacitors 36, 37. An in-phase component signal “I” of the intermediate frequency signal IF supplied from the mixer 2 (“IF(I)” in the drawing) is introduced to the positive input terminal and negative input terminal of the operational amplifier 31 via the variable resistances 32 and 33 respectively. One end and the other end of the variable resistance 34 are connected to the positive input terminal and negative output terminal of the operational amplifier 31 respectively. One end and the other end of the variable capacitor 36 are connected to the positive input terminal and negative output terminal of the operational amplifier 31 respectively. One end and other end of the variable resistance 35 are connected to the negative input terminal and positive output terminal of the operational amplifier 31 respectively. One end and the other end of the variable capacitor 37 are connected to the negative input terminal and positive output terminal of the operational amplifier 31 respectively. The resistance values of the variable resistances 32-35 and the capacitance values of the variable capacitors 36, 37 are set to values decided by the filter control data GD respectively.

The second active filter AF2 includes an operational amplifier 41, variable resistances 42-45, and variable capacitors 46, 47. A quadrature-phase component signal Q of the intermediate frequency signal IF supplied from the mixer 2 (“IF(Q)” in FIG. 4) is sent to the positive input terminal and negative input terminal of the operational amplifier 41 via the variable resistances 42 and 43 respectively. One end and the other end of the variable resistance 44 are connected to the positive input terminal and negative output terminal of the operational amplifier 41 respectively. One end and the other end of the variable capacitor 46 are connected to the positive input terminal and negative output terminal of the operational amplifier 41 respectively. One end and the other end of the variable resistance 45 are connected to the negative input terminal and positive output terminal of the operational amplifier 41 respectively. One end and the other end of the variable capacitor 47 are connected to the negative input terminal and positive output terminal of the operational amplifier 41 respectively. The resistance values of the variable resistances 42-45 and the capacity values (capacitances) of the variable capacitors 46, 47 are set to those values which are decided by the filter control data GD respectively.

The positive output terminal of the operational amplifier 31 is connected to the positive input terminal of the operational amplifier 41 via a variable resistance 53. The negative output terminal of the operational amplifier 31 is coupled to the negative input terminal of the operational amplifier 41 via a variable resistance 54. The negative output terminal of the operational amplifier 41 is coupled to the positive input terminal of the operational amplifier 31 via a variable resistance 51. The positive output terminal of the operational amplifier 41 is connected to the negative input terminal of the operational amplifier 31 via a variable resistance 52. An output current of each of the operational amplifiers 31, 41 is 10 microampere (μA), for example.

In the first active filter AF1, the in-phase component signal “I” of the intermediate frequency signal IF supplied from the mixer 2 (IF(I)) is subjected to the frequency selection processing with the filter characteristic based on (or decided by) the filter control data GD. As a result, the first active filter AF1 generates an intermediate frequency signal IFX(I). In the second active filter AF2, the quadrature-phase component signal Q of the intermediate frequency signal IF (IF(Q)) is subjected to the frequency selection processing with the filter characteristic based on the filter control data GD. Thus, the second active filter AF2 generates an intermediate frequency signal IFX(Q).

The operation to change the filter characteristic of the BPF 3 will be described below.

When the received signal strength of the signal receiving apparatus 20 is weaker than the threshold intensity RG, the received signal strength determination circuit 11 supplies the flag GF of the logical level 0 indicating low signal strength to the selector 12. Accordingly, the selector 12 selects and supplies the low intensity signal filtering control data G2 from the low intensity signal control data register 24 to the BPF 3 as the filter control data GD.

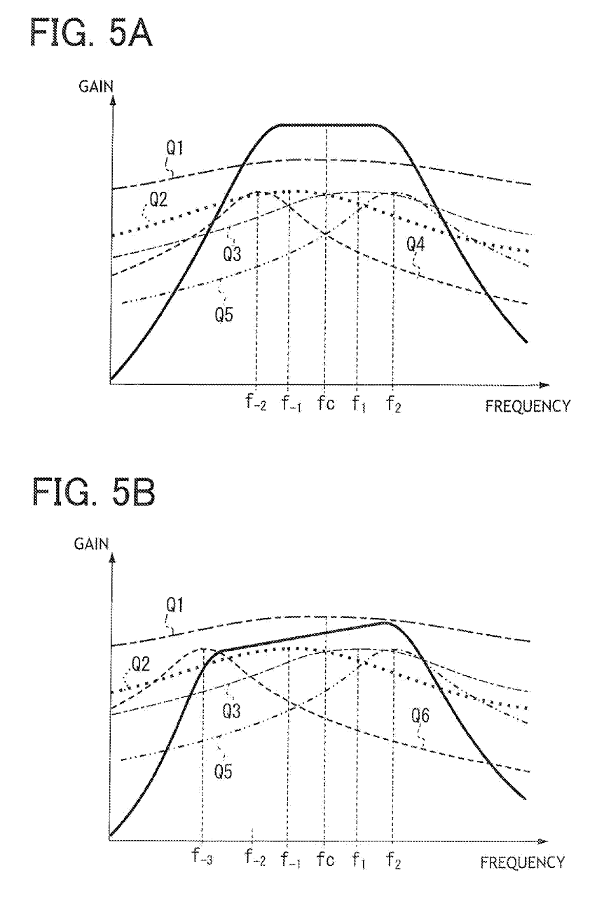

The low intensity signal filtering control data G2 specifies resistance values of the variable resistances 32-35, 42-45, 51-54 and capacitance values of the variable capacitors 36, 37, 46, 47 for each of the variable characteristic filters F1-F5 illustrated in FIG. 3. It should be noted that the resistance values of the resistances 32-35, 42-45, 51-54 and the capacitance values of the capacitors 36, 37, 46, 47 are collectively referred to as a filter characteristic parameter in this specification. The filter characteristic parameter contained (or carried) in the control data G2 for the filter F1 includes a set of values to make the filter F1 function as the BPF having the frequency characteristic Q1 illustrated in FIG. 5A with the center frequency fc being at its center. The filter characteristic parameter in the control data G2 for the filter F2 includes a set of values to cause the filter F2 to function as the BPF having the frequency characteristic Q2 illustrated in FIG. 5A with the frequency f₋₁ at its center that is lower than the center frequency fc. The filter characteristic parameter in the control data G2 for the filter F3 includes a set of values to cause the filter F3 to function as the BPF having the frequency characteristic Q3 illustrated in FIG. 5A with the frequency f₁ at its center that is higher than the center frequency fc. The filter characteristic parameter in the control data G2 for the filter F4 includes a set of values to cause the filter F4 to function as the BPF having the frequency characteristic Q4 illustrated in FIG. 5A with the frequency f-₂ at its center that is lower than the frequency f-₁. The filter characteristic parameter in the control data G2 for the filter F5 includes a set of values to cause the filter F5 to function as the BPF having the frequency characteristic Q5 illustrated in FIG. 5A with the frequency f₂ at its center that is higher than the frequency f₁.

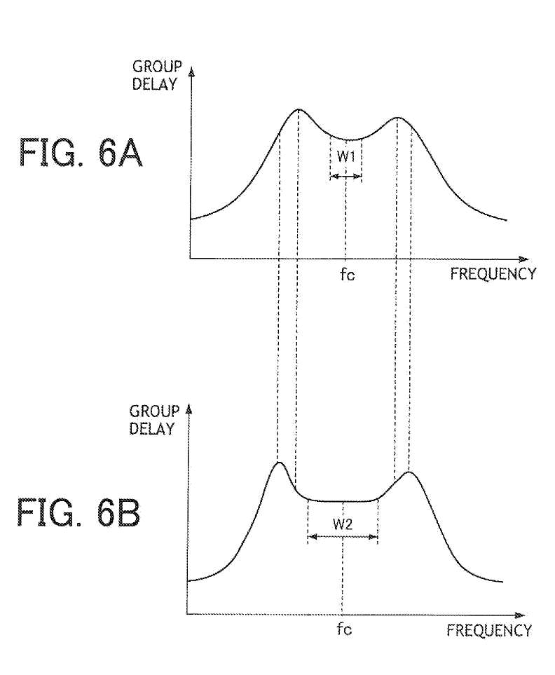

As shown in FIG. 5A, the five frequency characteristic curves Q1-Q5 make a composite frequency characteristic curve represented by the solid line. In other words, the low intensity signal filtering control data G2 causes the BPF 3 to function as the filter having the illustrated composite frequency characteristic. Specifically, the BPF 3 becomes the BPF having a steep interruption characteristic as indicated by the solid line in FIG. 5A by synthesizing the filter characteristics of the five filters F1-F5. The state in which the filter characteristic of the BPF 3 is set by the low intensity signal filtering control data G2 is referred to as a low received signal intensity mode. The BPF 3 in this low received signal intensity mode has the group delay characteristic as illustrated in FIG. 6A, for example.

On the other hand, when the received signal strength of the signal receiving apparatus 20 is stronger than the threshold intensity RG, the received signal strength determining circuit 11 supplies the flag GF of the logical level 1 indicating arrival of high intensity signal to the selector 12. Accordingly, the selector 12 selects and supplies the high intensity signal filtering control data G1 from the high intensity signal control data register 23 to the BPF 3 as the filter control data GD. Similar to the low intensity signal filtering control data G2, the high intensity signal filtering control data G1 specifies the filter characteristic parameters of the variable characteristic filters F1-F5 individually.

With respect to the filter characteristic parameters for the variable characteristic filters F1-F3 and F5, the high intensity signal filtering control data G1 is the same as the low intensity signal filtering control data G2. The filter characteristic parameter for the variable characteristic filter F4 is only different in this embodiment. The filter characteristic parameter in the control data G1 for the filter F4 includes a set of values that cause the filter F4 to function as the BPF that has the frequency characteristic Q6 illustrated in FIG. 5B with the frequency f-₃ at its center that is lower than the frequency f-₂. In other words, the control data G1 biases (or shifts) the center frequency of the pass band of the variable characteristic filter F4 that has a high(er) Q value among the five filters F1-F5 to the frequency f-₃ from the frequency f-₂ as illustrated in FIG. 5B.

As shown in FIG. 5B, the five frequency characteristic curves Q1-Q3, Q5 and Q6 make a composite frequency characteristic curve represented by the solid line. In other words, the high intensity signal filtering control data G1 causes the BPF 3 to function as the filter having the illustrated composite frequency characteristic made from the frequency characteristic curves Q1-Q3, Q5 and Q6. The state in which the filter characteristic of the BPF 3 is set by the high intensity signal filtering control data G1 is referred to as a high received signal intensity mode. In the high received signal intensity mode, the BPF 3 has a smaller amount of phase rotation, i.e., a smaller amount of change in the group delay than in the low received signal intensity mode, since the center frequency of the variable characteristic filter F4 is shifted further away from the center frequency fc than in the low received signal intensity mode. The BPF 3 in the high received signal intensity mode has the group delay characteristic as illustrated in FIG. 6B, for example.

Therefore, the pass band of the BPF 3 in the high received signal intensity mode, which is indicated by the solid line in FIG. 5B, is wider than the pass band of that in the low received signal intensity mode which is indicated by the solid line in FIG. 5A. With regard to the band width in which a changing amount of the group delay with the center frequency fc of the pass band of the BPF 3 as the center is small, i.e., is flat, the band width W2 in the high received signal intensity mode as illustrated in FIG. 6B is wider than the band width W1 in the low received signal intensity mode as illustrated in FIG. 6A.

In short, when the received signal intensity RS is greater than the threshold intensity RG, the center frequency of at least one of the filters F1-F5 constituting the BPF 3 (i.e., the multi-filter device) is biased or shifted. By biasing the center frequency toward a direction away from the center frequency fc of the multi-filter device 3, the pass band width of the BPF becomes wider while the change amount of the group delay becomes smaller. Accordingly, even if the change of the group delay of the BPF becomes large due to the high received signal intensity and the center frequency of the received signal is deviated from the prescribed center frequency due to the frequency deviation on the signal transmitting apparatus side, or the initial deviation, temperature deviation or the like of the center frequency of the local oscillator on the signal receiving apparatus side, it is still possible to extract a signal IFX having a desired band for demodulation.

Therefore, by applying the signal receiving apparatus 20 of FIG. 2 to a transceiver or a wireless emergency notification system that may be used for short-range wireless communications, it becomes possible to significantly improve the communication accuracy of short-range communications compared to an approach of correcting communication troubles only with data error correction at the time of demodulation.

When the BPF 3 is switched from the low received signal intensity mode to the high received signal intensity mode in the illustrated embodiment, the center frequency of only the filter F4 is biased among the five filters F1-F5. It should be noted, however, that the center frequencies of two or more of the five filters F1-F5 may be biased or changed. By individually biasing the center frequencies of the two (or more) filters among the filters F1-F5, it becomes possible to further widen (expand) the pass band width of the BPF 3, or flatten the frequency characteristic. Also, the Q values (frequency band characteristics) of the respective variable characteristic filters F1-F5 may be changed in addition to biasing of the center frequency as described above. By individually changing the bands in addition to shifting of the center frequencies of some filters among the filters F1-F5, it becomes possible to obtain the desired filter characteristics more accurately.

If the received signal intensity of the RSSI circuit 8 does not have good reproducibility upon (or after) switching the BPF 3 to the low received signal intensity mode from the high received signal intensity mode, then the received signal intensity determination circuit 11 may be designed to have a hysteresis characteristic such that the determination circuit 11 can determine whether the received signal intensity changes from higher-than-the-threshold-intensity RG to lower-than-the-threshold-intensity RG.

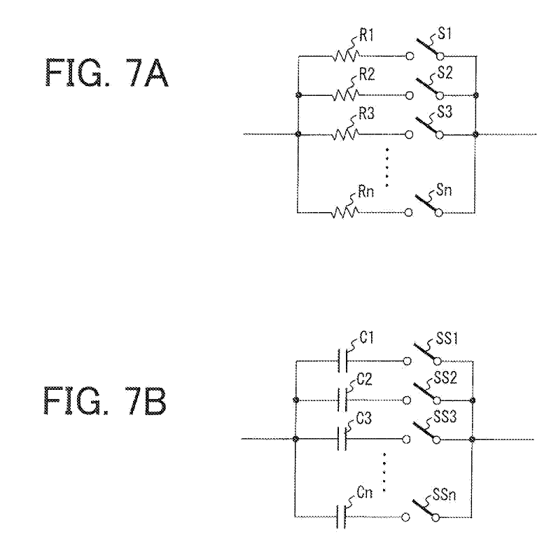

In the above-described embodiment, the changes of the filter characteristics of the filters F1-F5 are realized by controlling the variable resistances 32-35, 42-45 and 51-54, and the variable capacitors 36, 37, 46 and 47. It should be noted, however, that the present invention is not limited to this configuration. For example, the variable resistances 32-35, 42-45 and 51-54 shown in FIG. 4 may be replaced by switching elements S1-Sn and resistances R1-Rn as shown in FIG. 7A. A composite resistance value of the resistances R1-Rn may be changed by the filter control data GD that specifies (or decides) which switching element(s) of the switching elements S1-Sn should be turned on. Alternatively, the respective variable capacitors 36, 37, 46 and 47 shown in FIG. 4 may be replaced by switching elements SS1-SSn and capacitors C1-Cn as illustrated in FIG. 7B. A composite capacitance value of the capacitors C1-Cn may be changed by the filter control data GD that specifies (or decides) a suitable combination of switching elements to be turned on among the switching elements SS1-SSn.

Other changes and modifications may also be made to the illustrated embodiment. For example, although the BPF 3 is used to switch between the high received signal intensity mode and low received signal intensity mode in the embodiment, a direct conversion type low-pass filter may be employed instead of the band pass filter. More specifically, when the multi-filter device is a low-pass filter, and the received signal intensity RS is higher than the threshold value RG, then the center frequency of at least one filter among the multiple filters contained in the low-pass filter may be shifted away from the cut-off frequency of the low-pass filter toward a direction of the high range. Accordingly, when the received signal intensity is high, such biasing widens (or broadens) the pass band width of the low-pass filter and reduces the variations of the group delay.

This application is based on Japanese Patent Application No. 2011-106373 filed on May 11, 2011 and the entire disclosure thereof is incorporated herein by reference.

What is claimed is:

1. A signal receiving apparatus comprising:
a first module for receiving an incoming signal;
a second module for obtaining a frequency signal from the received signal;
a multi-filter device for applying frequency selection processing on the frequency signal to obtain a processed signal, said multi-filter device including a plurality of filters having different frequency characteristics from each other, said plurality of filters being connected to each other in series, each said filter having a center frequency and said multi-filter device having its own center frequency;
a demodulation part for demodulating the processed signal so as to obtain information and/or data;
a received signal intensity determination part for determining whether or not received signal intensity of the received signal is greater than threshold intensity; and
a controlling part for biasing the center frequency of at least one of said plurality of filters when the received signal intensity determination part determines that the received signal intensity is greater than the threshold intensity.

2. The signal receiving apparatus according to claim 1, wherein the multi-filter device includes a band pass filter and the controlling part biases the center frequency of the at least one filter toward a direction away from the center frequency of the multi-filter device.

3. The signal receiving apparatus according to claim 1, wherein the at least one filter has a Q value which is higher than Q values of other filters of said plurality of filters.

4. The signal receiving apparatus according to claim 1, wherein each said filter is an active filter.

5. The signal receiving apparatus according to claim 1, wherein the multi-filter device is a low-pass filter that has a cut-off frequency, and the controlling part biases the center frequency of the at lease one filter toward a higher range away from the cut-off frequency of the multi-filter device.

6. The signal receiving apparatus according to claim 5, wherein the at least one filter has a Q value which is higher than Q values of other filters of said plurality of filters.

7. The signal receiving apparatus according to claim 5, wherein each said filter is an active filter.

8. A control method for a multi-filter device provided in a signal receiving device, said multi-filter device including a plurality of filters having different frequency characteristics from each other and connected to each other in series, each said filter having a center frequency, said signal receiving device adapted to obtain a frequency signal from a received signal, and said multi-filter device adapted to apply frequency selection processing on the frequency signal, the control method comprising:
biasing the center frequency of at least one of said plurality of filters when received signal intensity of the received signal is greater than threshold intensity.

9. The control method for a multi-filter device according to claim 8, wherein the multi-filter device is a band pass filter.

10. The control method for a multi-filter device according to claim 8, wherein said biasing the center frequency of the at least one filter shifts the center frequency toward a direction away from a center frequency of the multi-filter device.

11. The control method for a multi-filter device according to claim 8, wherein the at least one filter has a Q value which is higher than Q values of other filters of said plurality of filters.

12. The control method for a multi-filter device according to claim 8, wherein each said filter is an active filter.

13. The control method for a multi-filter device according to claim 8, wherein the multi-filter device includes a low-pass filter having a cut-off frequency, and said biasing the center frequency of the at least one filter shifts the center frequency of the at least one filter toward a direction of a high range away from the cut-off frequency of the multi-filter device.

14. The control method for a multi-filter device according to claim 13, wherein the at least one filter has a Q value which is higher than Q values of other filters of said plurality of filters.

15. The control method for a multi-filter device according to claim 13, wherein each said filter is an active filter.

16. The control method for a multi-filter device according to claim 8 further comprising determining whether the received signal intensity is greater than the threshold intensity.

17. A method for use in a signal receiving device having a multi-filter device, said multi-filter device including a plurality of filters having different frequency characteristics from each other and connected to each other in series, each said filter having a center frequency, the method comprising:
causing the signal receiving device to receive an incoming signal;
obtaining a frequency signal from the received signal;
causing the multi-filter device to apply frequency selection processing on the frequency signal;
determining whether received signal intensity of the received signal is greater than threshold intensity;
biasing the center frequency of at least one of said plurality of filters when the received signal intensity of the received signal is greater than the threshold intensity;
demodulating the frequency signal that has undergone the frequency selection processing; and
causing the signal receiving apparatus to output the demodulated signal.

18. The method according to claim 17, wherein the multi-filter device is a band pass filter.

19. The method according to claim 17, wherein said biasing the center frequency of the at least one filter shifts the center frequency of the at least one filter toward a direction away from a center frequency of the multi-filter device.

20. The method according to claim 17, wherein the multi-filter device includes a low-pass filter having a cut-off frequency, and said biasing the center frequency of the at least one filter shifts the center frequency of the at least one filter toward a direction of a high range away from the cut-off frequency of the multi-filter device.
